(19) United States
(12) Patent Application Publication
(10) Pub. No.: US 2016/0139584 A1
(43) Pub. Date: May 19, 2016

(54) OPTIMIZATION OF GIMBAL CONTROL LOOPS USING DYNAMICALLY MEASURED FRICTION

(71) Applicant: BAE SYSTEMS INFORMATION AND ELECTRONIC SYSTEMS INTEGRATION INC., Nashua, NH (US)

(72) Inventors: Clifford D. Caseley, Hudson, NH (US); Austin J. Dionne, Chester, NH (US); Paul F. Messier, Nashua, NH (US)

(73) Assignee: BAE SYSTEMS INFORMATION AND ELECTRONIC SYSTEMS INTEGRATION INC.

(21) Appl. No.: 14/943,105

(22) Filed: Nov. 17, 2015

Related U.S. Application Data
(60) Provisional application No. 62/080,691, filed on Nov. 17, 2014.

(51) Int. Cl. G05B 19/19

(52) U.S. Cl. CPC G05B 19/19

(57) ABSTRACT

A method to slew a gimbal axis in an infrared countermeasures system (IRCM) comprising the steps of driving the motors up to the peak currents allowed by the servo amplifiers, moving the profile generator from firmware to software for design flexibility, forcing high torque by manipulating the angle waveform sent to hardware, measuring friction during acceleration of each slew, providing a dynamic rate limit for receding or advancing angle goals is presented in this application.

### CROSS-REFERENCE TO RELATED APPLICATIONS

This application claims the benefit of U.S. Provisional Patent Application Ser. No. 62/080,691, filed Nov. 17, 2014, the entire specification of which is incorporated herein by reference.

### BACKGROUND

1. Technical Field

Generally the application relates to electronic countermeasures and more particularly to infrared countermeasures systems. More particularly, the application relates to a gimbal system which comprises azimuth and elevation axes utilized in infrared countermeasure systems. Specifically, this application is directed to a method to measure gimbal friction dynamically at the beginning of a slew event so that a deceleration profile can be generated to position gimbal axes at the target angle.

2. Background Information

Optimizing a weapon slew to assure that it moves quickly is becoming ever more important. Thus, to slew a gimbal axis as quickly as possible to match a target angle and angular rate requires knowledge of friction, inertia, and saturation motor torque. Generally, knowledge of friction is the most essential element to calculate the perfect switchover time from acceleration to deceleration. Unfortunately, friction is considered to be a difficult parameter to calibrate since it depends on a number of different condition such as: (1) temperature of the lubricant; (2) axial and radial preloads that depend on temperature coefficients of expansion in steady-state; (3) axial and radial preloads that vary with temperature gradients in transient conditions; (4) wear; and (5) lubricant aging. Thus, factory calibration on sensors must be followed to keep updated all conditions of a gimbal system, which is expensive and only partially effective. A novel and improved way to slew a gimbal axis is, therefore, needed.

### SUMMARY

In one aspect, the system provides a method to slew a gimbal axis in an infrared countermeasure system (IRCM), wherein the method comprises: 1) providing a motor with a high torque; 2) driving the motor to the peak current by a servo amplifier; 3) generating a maximum acceleration of a gimbal axis in a profile generator using a loop controlling current; 4) measuring friction of the gimbal axis during acceleration of the gimbal axis; 5) applying the measured friction to the calculation of an optimum deceleration rate for the gimbal axis; 6) selecting a dynamic rate limit for a target angle based on a polarity of an angle change and a direction of a predicted angular rate at an end of a slew event; and 7) providing the dynamic rate limit to the gimbal axis to slew the gimbal axis.

In another aspect, the system provides a method to slew a gimbal axis in an infrared countermeasure system (IRCM), wherein the method comprises: 1) engaging a latch set to a loop rate; 2) measuring an estimated friction during acceleration of a gimbal axis; 3) calculating a threshold rate of the gimbal axis; 4) comparing a gimbal rate of the gimbal axis with the calculated threshold rate; 5) switching from a current loop to a rate loop; and 6) forcing a profile angle to follow an angle from a target tracker.

### BRIEF DESCRIPTION OF THE DRAWINGS

A sample embodiment of the present disclosure is set forth in the following description, is shown in the drawings and is particular and distinctly pointed out and set forth in the appended claims. The accompanying drawings, which are fully incorporated herein and constitute a part of the specification, illustrate various examples, methods, and other example embodiments of various aspects of the present disclosure. It will be appreciated that the illustrated element boundaries (e.g., boxes, group of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is an exemplary environmental schematic view of defensive infrared countermeasure systems.

FIG. 2 is an enlarged side view of an electro-optical system mounted on a gimbal system;

FIG. 3 is a schematic drawing showing an overview of the control for one gimbal axis;

FIG. 4 is a schematic drawing showing a flow chart of the control for one gimbal axis;

FIG. 5 is a schematic drawing showing indirect control of motor current by the profile generator during acceleration;

FIG. 6 is a schematic drawing showing the calculation of gimbal angle with no friction; and

FIG. 7 is a schematic drawing showing the profile generator rate and loops for rate and position to generate angle waveform.

Similar numbers refer to similar parts throughout the drawings.

### DETAILED DESCRIPTION OF THE EMBODIMENT

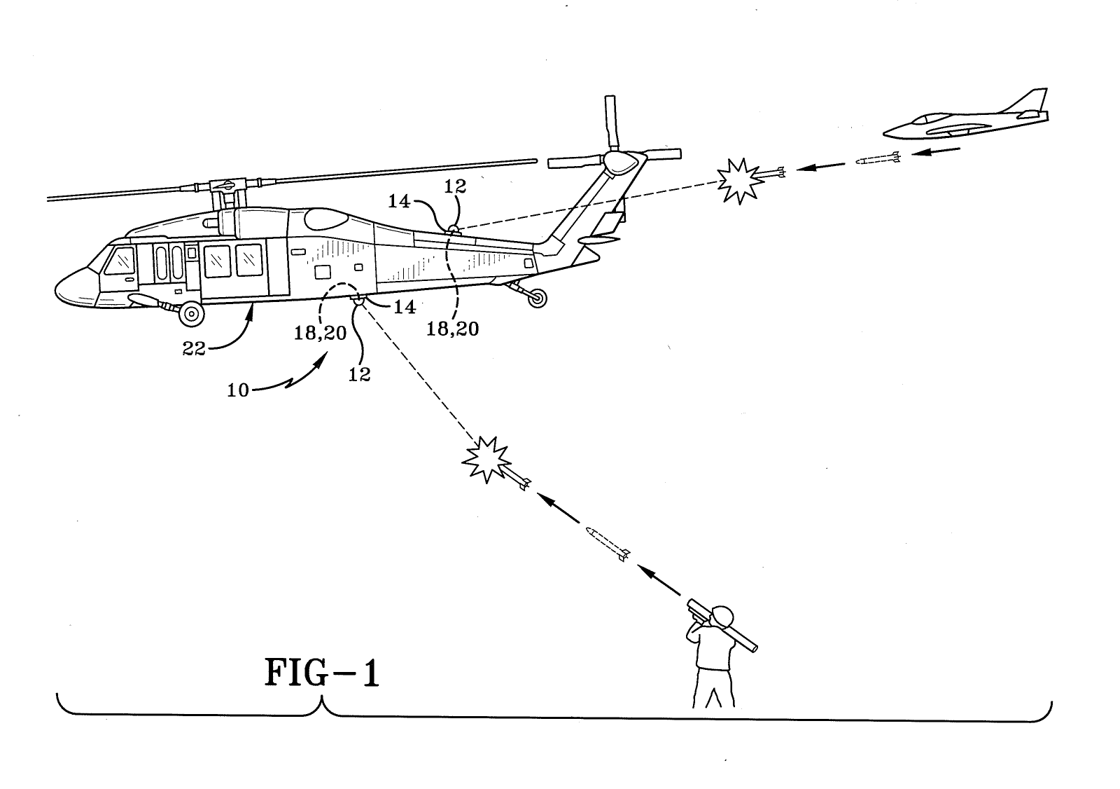

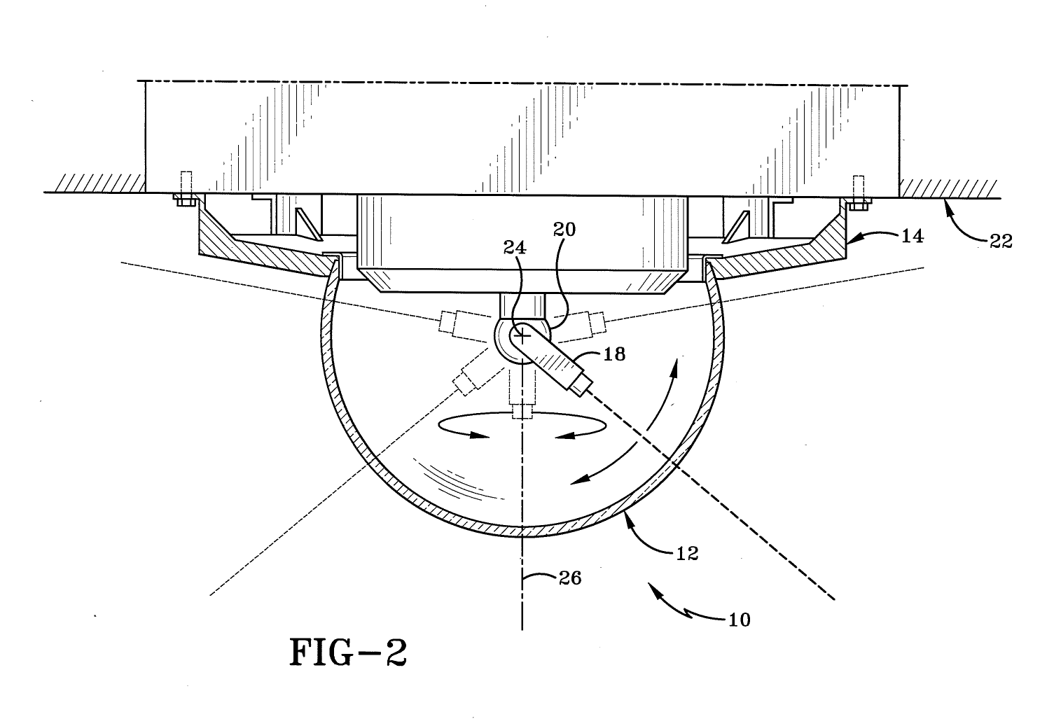

The current application is related to a countermeasure system which is mounted on an aircraft. As depicted in FIG. 1, the countermeasure system is mounted on aircraft 22. Aircraft 22 is depicted as a helicopter but may be any other form of flying device as one having ordinary skill in the art would understand. By way of a brief introduction, infrared countermeasure system 10 is a device designed to protect aircraft from infrared homing (“heat seeking”) missiles by confusing the missiles' infrared guidance system so that they will miss their target (Electronic countermeasure). Referring to FIG. 2, the countermeasure system 10 comprises infrared (IR) transparent dome 12, a dome base 14, an electro-optical (EO) system 18, and a gimbal system 20. Electro-optical system 18 is further mounted on gimbal system 20. Gimbal system 20 enables electro-optical system 18 to move in vertical and horizontal directions freely so that electro-optical system 18 mounted on gimbal system 20 can point in any direction.

As depicted in FIG. 2, electro-optical system 18 is mounted on gimbal system 20 so that the module can rotate 180 degrees in vertical and horizontal directions to detect threats or enemies. Gimbal system 20 turns 360 degrees around a first gimbal axis 26. Furthermore, gimbal system 20 turns approximately 360 degrees around a second gimbal axis 24 as well. Second gimbal axis 24 is shown as extending into and out of the page on Sheet 2/5. Since electro-optical system 18 is sufficiently firmly attached to gimbal system 20, electro-optical system 18 will turn the same angle as gimbal system 20 turns.

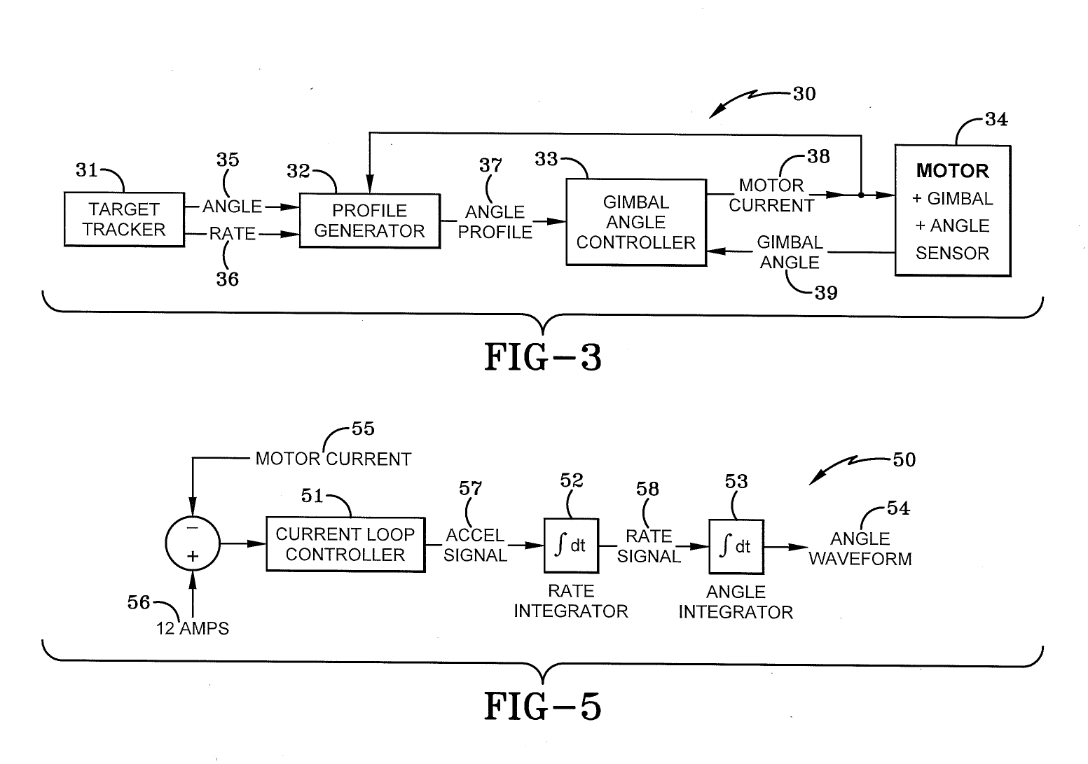

FIG. 3 depicts a block diagram of the overall method of controlling one gimbal axis (either 24 or 26) on gimbal system 20. Overall, a gimbal axis controlling system 30 includes both control of target angle (position) and target rate (angular velocity) as goals to be achieved at the end of each slew event so that gimbal axis controlling system 30 can effectively control the position of the gimbal axis within the shortest possible timeframe. Particularly, gimbal axis controlling system 30 comprises a target tracker 31, a profile generator 32, a gimbal angle controller 33, and a motor 34. Target tracker 31 is a device that can be used to sense or detect ongoing threats or enemies. At the same time, target tracker 31 can send signals to other components in gimbal axis controlling system 30 to follow the ongoing threats. In this application, target tracker 31 utilizes multiple data as inputs. These inputs are later used to communicate with profile generator 32. The first data input is an angle 35, and the second data input is a rate 36. Input data can be gathered by target tracker 31, and sent to profile generator 32. Profile generator 32 is a device that can generate an angle profile 37 to gimbal angle controller 33. Particularly, profile generator 32 is a firmware that can be easily programed. Here, profile generator 32 is implemented in a Field-Programmable Gate Array (FPGA) running at a rate of 6 KHz to generate an angle profile 37. Angle profile 37 is then sent to a gimbal angle controller 33. Gimbal angle controller 33 is a physical controller which is directly or indirectly connected with a motor 34 so that it can govern actual motion of a motor 34. Angle profile 37 which enters gimbal angle controller 33 as an input can produce a motor current 38 which is used as an input to motor 34. Gimbal angle controller 33 which controls an azimuth and elevation axes responds to angle commands from profile generator 32. Generally, the elevation angle is controlled in the same way (but with different parameters) as the azimuth axis. Gimbal angle controller 33 transforms angle profile 37 to motor current 38 so that motor 34 can track the target angle in accordance with the level of motor current 38. Motor current 38 is also sent back to profile generator 32 so that the current data from motor 34 is used as a feedback current data to generate angle profile 37. Additionally, since motor 34 which is directly attached to the gimbal axis (either 24 or 26) takes not only current data, but also produces a gimbal angle 39 using an angle sensor attached to motor 34. Thus, any angle changes occurring during the movement of motor 34 can be informed to gimbal angle controller 33 so that gimbal angle controller 33 can use the angle data to control motor current 38.

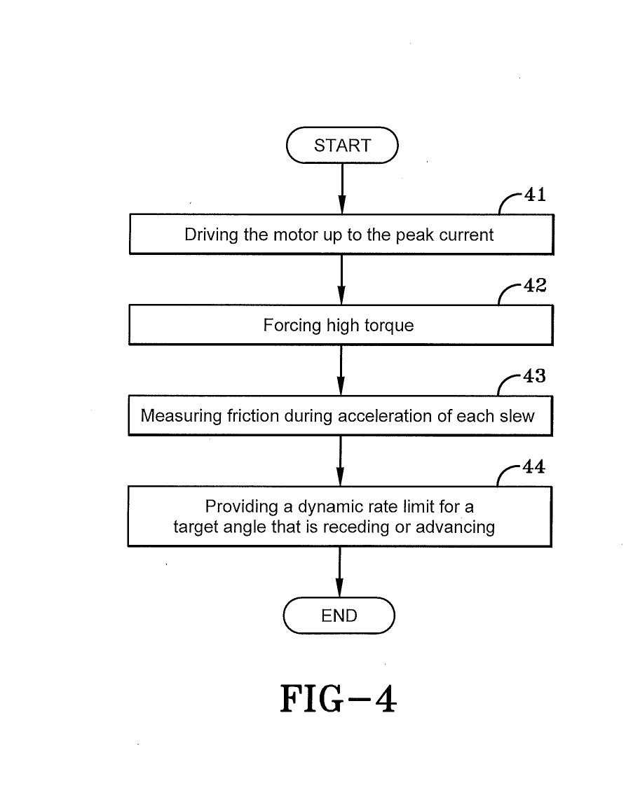

As depicted in FIG. 4, the detailed steps associated with the slewing of any gimbal axis 24 or 26 to match a target angle and rate may be carried out by the following steps: (1) driving the motor up to the peak current 41; (2) forcing high torque 42; (3) measuring friction during acceleration of each slew 43; and (4) providing a dynamic rate limit for a target angle that is receding or advancing 44. In driving the motor up to a peak current, a servo amplifier is required to produce the peak current. Particularly, the current of the motor is regulated at near maximum for maximum acceleration under a loop control so that a gimbal angle controller does not saturate. Particularly, in this application, the motor which can deliver 734 oz-in at 8.98 amperes is used. Furthermore, a servo amplifier which is capable of delivering 12.5 amperes of current drives the motor. Typically, more torque can be delivered at higher currents as long as the motor is not damaged. However, the motor can be damaged if it overheats windings. Thus, in this application, software is developed to provide protection by monitoring the current over time and shutting down the motor when a threshold is exceeded to prevent damage to the motor. In forcing high torque, an angle waveform which is sent from a profile generator to a gimbal angle controller is manipulated to produce sufficient torque. In measuring friction during acceleration of each slew, motor current, torque constant, and load inertia are used to calculate a running estimate of the angle that would be achieved with no friction. Then, a running estimate of friction can be calculated based on the difference between the calculated gimbal angle without friction and the measured angle over the time interval. The friction estimate allows a running estimate of deceleration capability which in turn provides an accurate estimate of time to switch from acceleration to deceleration. The calculation of running estimate of friction during acceleration is discussed in details later. As depicted in FIG. 5, an angle waveform 54 is generated by a loop closure function 50. Loop closure function 50 is the function performed by profile generator 32 during the acceleration portion of a slew event. The feedback in the loop is shown as a motor current 55 in FIG. 5 and as a motor current 38 in FIG. 3. Loop action forces angle waveform 54 that gimbal angle 39 can follow with 12 amperes of motor current. The error signal in the loop is the difference between motor current 55 and a reference value of 12 amperes 56. The signal is sent to current loop controller 51 which transforms the error signal to a corresponding acceleration signal 57 using a proportional plus integral (PI) control. Then, acceleration signal 57 is applied to two electronic integrators in series. Here, the integrators are functioned as accumulators which are implemented with difference equations. The input to a rate integrator 52 is acceleration signal 57 generated by current loop controller 51. The output of rate integrator 52 is rate signal 58 which is an input to an angle integrator 53. The output of angle integrator 53 is angle waveform 54. Angle waveform 54 is angle profile 37 sent to gimbal angle controller 33 as depicted in FIG. 3 while loop closure function 50 is engaged. During a slew event as well as during a subsequent target tracking event, gimbal angle 39 may track angle waveform 54 within small errors because loop 50 generates angle waveform 54 that gimbal angle controller 33 can follow with maximum acceleration without saturating. Here, since loop 50 keeps the motor current at 12 amperes which is below the saturation value of 12.5 amperes, angle waveform 54 presented to gimbal angle controller 33 is within the capability of gimbal system 20. If angle waveform 54 from profile generator 32 increases too fast, the gimbal would fall behind, and current would increase above the 12 amperes set point. On the other hand, if angle waveform 54 from profile generator 32 increases too slowly, gimbal angle controller 33 would track with current less than the 12 amperes set point. In this manner, profile generator 32 prevents saturation of gimbal angle controller 33 and allows achieving maximum acceleration in spite of unknown value of friction.

As depicted in FIG. 5, during the acceleration of each slew event, acceleration presented to rate integrator 52 is reduced due to the effect of friction. In other words, angle waveform 54 is affected by fictional force, and so it contains friction information. Particularly, the information can be extracted by comparing the achieved angle with the angle that would be achieved without friction. The angle that would be achieved without friction is calculated with a control model 60 depicted in FIG. 6. Similar to FIG. 5, control model 60 contains two integrators in series. The first integrator is a rate integrator 67, and the other integrator is an angle integrator 68. In control model 60, acceleration without friction 61 is calculated by multiplying motor current 38 in FIG. 3 (also shown as motor current 55 in FIG. 5) times the motor torque constant and dividing by the load inertia. Acceleration without friction 61 is then sent to rate integrator 67 as an input. The output from rate integrator 67 is then transferred to angle integrator 68 to calculate an angle waveform without friction 69. Particularly, an angle waveform produced here is angle waveform without fiction 69 that would be achieved if there were no friction.

If θₘₑₐₛ is assumed as the measured angle change over interval (T) with friction, Δθ₀ is assumed as gimbal angle change at time T due to an initial gimbal rate, and Δθₘ, is assumed as gimbal angle change due to motor torque alone, then the measured friction torque (F) can be calculated since the values of ηₘₑₐₛ,Δη₀, and Δηₘ, can be measured during acceleration. Thus, the friction torque (F) can be calculated, which is:

$$F = \frac{2 \cdot J}{{T}^{2}} \cdot ( Δ {θ}_{m} + Δ {θ}_{0} - Δ {θ}_{meas} )$$

where:
   T: elapsed time since start of acceleration
   J: gimbal load inertia

At the end of each slew event, slew can be either receding or advancing. For the receding target angle, current loop controller 51 will accelerate a gimbal rate of any gimbal axis 24 or 26 to a peak rate, and switch to deceleration to match the target angle and rate, so that the same gimbal axis will not experience overshoot. However, sometimes, the target angle for slew is advancing, which means that the target rate brings the target angle closer to the current gimbal angle. In such case, a quick response requires a gimbal rate of any gimbal axis 24 or 26 to accelerate toward the target angle, decelerate it to a zero rate before reaching the target angle, and then accelerate it to match the target angle and rate simultaneously. Here, a decision for using a receding or advancing algorithm is accomplished at the beginning of slew event. Particularly, the decision is based on the polarity of the angle change needed and the direction of the predicted angular rate at the end of slew.

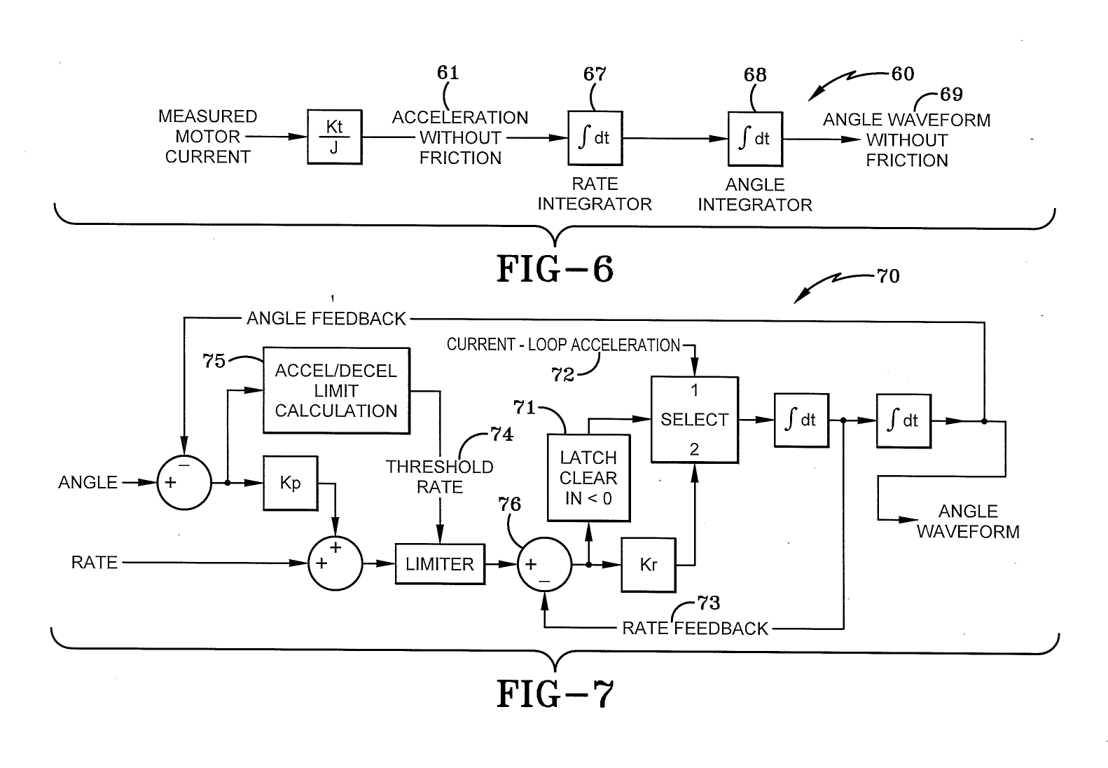

As depicted in FIG. 7, a control loop 70 comprises an inner loop on rate and an outer loop on position. The position loop is constantly creating rate commands to the inner loop on rate adding to the rate commands from the tracker. The gimbal rate error diminishes quickly responding to the rate profile at the limiter. When the rate error gets small enough, the rate loop comes out of limit and the position loop finishes the slew to match the target angle and rate with no overshoot.

Particularly, providing a dynamic rate limit proceeds as follows. At start of each slew event, a latch 71 initially is set to engage with a current-loop acceleration 72 which is also depicted as acceleration signal 57 in FIG. 5 to produce maximum acceleration. During acceleration, friction value is measured in the manner as disclosed above, and the measured friction value is used to estimate the maximum deceleration possible. At each moment during slew, a gimbal rate 73 is compared with a maximum threshold rate 74 which can be decelerated down to match a target rate without overshoot. Particularly, the calculation of maximum threshold rate 74 is performed in a limit calculation block 75. In this manner, measured friction play an important role to calculate maximum threshold rate 74. The comparison appears at a point 76, where gimbal rate 73 is compared to limiter output as shown in FIG. 7.

More particularly, when the accelerating rate equals the calculated threshold rate, the latch resets to disengage the current-control loop, and engage the rate loop (Select 2 in FIG, 7). With the rate loop engaged, the profile generator is configured to force a profile angle to follow the angle from the target tracker. However, the loop is subject to the limitations imposed by the limiter. Threshold rate 74 applied at the limiter remains a dynamic signal since it calculates a new value on each iteration, and updates constantly by providing a high level of deceleration within the capability of the gimbal to follow. This dynamic threshold value becomes the rate profile that the gimbal follows until the gimbal angle gets close to the angle from the target tracker. Without the limiter, the profile generator could create a waveform that the gimbal could not follow, and the angle of the profile generator would no longer reflect the gimbal angle. Thus, it would spoil the quickness of slew since the gimbal angle controller would saturate and it takes a long time to recover.

The design of the rate profile to the limiter gives a high value of constant deceleration. There is a slight modification in the profile function so that the profile deceleration matches the loop deceleration at the moment the rate loop comes out of limit to prevent a step disturbance that will increase slew time.

Those skilled in the art will appreciate that this solution has the following benefits: (1) the solution requires no added hardware because the system is implemented in software and firmware (i.e. profile generator); (2) does not require factory calibration of each unit over temperature, which is expensive and time consuming; (3) friction is measured at the moment of use; (4) all sources are accounted for temperature, wear, lubricant state of the gimbal (5) quickest possible slew for each given friction condition is achieved.

While the present present disclosure has been described in connection with the preferred embodiments of the various figures, it is to be understood that other similar embodiments may be used or modifications or additions may be made to the described embodiment for performing the same function of the present present disclosure without deviating therefrom. Therefore, the present present disclosure should not be limited to any single embodiment, but rather construed in breadth and scope in accordance with the recitation of the appended claims.

What is claimed is:

1. A method to slew a gimbal axis in an infrared countermeasure system comprising the steps of:
providing a motor with a high torque;
driving the motor to the peak current by a servo amplifier;
generating a maximum acceleration of a gimbal axis in a profile generator using a loop controlling current;
measuring friction of the gimbal axis during acceleration of the gimbal axis;
applying the measured friction to calculation of an optimum deceleration rate for the gimbal axis;
selecting a dynamic rate limit for a target angle based on a polarity of an angle change and a direction of a predicted angular rate at an end of a slew event; and
providing the dynamic rate limit to the gimbal axis to slew the gimbal axis.

2. The method of claim 1, wherein the target angle is a receding target angle.

3. The method of claim 2, wherein the receding target angle is defined as an increase of slew distance with respect to time,

4. The method of claim 2, wherein the step of providing the dynamic rate limit for the receding target angle further comprises the steps of:
accelerating a gimbal rate of the gimbal axis to a peak rate; and
switching to deceleration to match a target angle and a target rate without experiencing overshoot.

5. The method of claim 1, wherein the target angle is an advancing target angle.

6. The method of claim 5, wherein the advancing target angle is defined as a decrease of slew distance with respect to time.

7. The method of claim 5, wherein the step of providing a dynamic rate limit for the advancing target angle further comprises the steps of:
accelerating a gimbal rate of the gimbal axis toward a target angle;
decelerating the gimbal rate of the gimbal axis to a zero before reaching the target angle; and
accelerating the gimbal rate of the gimbal axis to match the target rate and angle simultaneously.

8. The method of claim 1, wherein the step of driving the motor to the peak current is further accomplished by driving the motor to a level where a torque begins to saturate.

9. The method of claim 1, wherein the step of generating the maximum acceleration is further accomplished by providing a maximum motor current.

10. The method of claim 9, wherein the step of measuring friction during acceleration is further accomplished by two electric integrators in series.

11. The method claim 1, wherein the step of generating maximum acceleration of the gimbal axis in the profile generator is further accomplished by tracking the loop.

12. The method claim 1, wherein the step of measuring friction during acceleration is further accomplished by a proportional and integrator controller.

13. The method of claim 1, wherein the step of measuring friction during acceleration is further accomplished by comparing an angle achieved without friction to an angle achieved with friction.

14. The method of claim 13, wherein the angle achieved without friction is further calculated in another control loop which comprises a pair of integrators.

15. A method to slew a gimbal axis in an infrared countermeasure system comprising the steps of:
engaging a latch set to a loop rate;
measuring an estimated friction during acceleration of a gimbal axis;
calculating a threshold rate of the gimbal axis;
comparing a gimbal rate of the gimbal axis with the calculated threshold rate;
switching from a current loop to a rate loop; and
forcing a profile angle to follow an angle from a target tracker.

16. The method of claim 15, wherein the step of switching from the current loop to the rate loop occurs when the accelerating rate is equal to the calculated threshold rate.

17. The method of claim 15, wherein the calculated threshold rate is a dynamic threshold rate.

18. The system of claim 15, wherein the dynamic threshold rate calculate a new value on each iteration.

19. The method of claim 17, wherein the dynamic threshold rate includes a rate profile that a gimbal axis follows until a gimbal angle nears an angle from the target tracker.

20. The method of claim 15, wherein the step of calculating the threshold rate is further accomplished by limiting rate with a limiter. 2
